(19) United States
(12) Patent Application Publication
(10) Pub. No.: US 2008/0065727 A1
(43) Pub. Date: Mar. 13, 2008

(54) Conferencing system with improved access

(76) Inventors: Kenneth D. Majors, Lake Oswego, OR (US); Scott Deboy, Hillsboro, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/900,840

(22) Filed: Sep. 12, 2007

Related U.S. Application Data
(60) Provisional application No. 60/844,497, filed on Sep. 13, 2006.

(51) Int. Cl. G06F 15/173

(52) U.S. Cl. 709/205

(57) ABSTRACT

A conferencing system includes a plurality of users each of which is interconnected with a conferencing server that permits videoconferencing among said plurality of users. The conferencing server permits each of the plurality of users to access a document of the conferencing server using an authentication process. The conferencing server permits another user to access the document of the conferencing server without using the authentication process. The another user accessing the document is in response to a request by one of the plurality of users.

### CROSS-REFERENCE TO RELATED APPLICATIONS

The present application claims the benefit of 60/844,497, filed Sep. 13, 2006.

### BACKGROUND OF THE INVENTION

The present invention relates to a conferencing system and, more particularly, to a computer-based conferencing system enabling viewers to effectively conference among themselves.

Many business activities are performed by teams of individuals that may be widely dispersed geographically. For example, product design and manufacturing are commonly performed by teams having members who are often located in facilities spread around the globe and/or who may be in transit between locations. If a decision is to be made concerning the project it may be necessary to quickly gather input and consensus from the members of the team regardless of their physical remoteness. Modern communication technology enables individuals to communicate over long distances and from remote locations. Conferencing systems facilitate communication between a plurality of remotely located users or conferees by allowing multiple users to communicatively interconnect with each other either directly as peers or by interconnecting with a central server that is interconnected to the other participants in the conference. Computer-based conferencing systems commonly provide for audio and video input from each of the conferees. In addition, a conferencing system may provide file sharing enabling conferees to view and edit files, including engineering drawings and spreadsheets that are part of the team's project.

One goal of a conferencing system is to connect a plurality of remotely located conferees and enable communication between the conferees as if the conferees were sitting at the same conference table. However, as the number of conference locations, sources of video, audio or other data input to the conference, increases, the ability of a group to communicate effectively in a conference decreases. For example, a separate transport stream, commonly comprising audio, video and textual data streams, is required for each conference location.

In many cases, for additional participants to join a conferencing session, they are required to sign into the conferencing system. This typically requires an account, a password, and knowledge of how to navigate the conferencing system.

What is desired, therefore, is a conferencing system that enables the members of a group of participants in a conference and to effectively discuss the presentation.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a conferencing system.

FIG. 2 illustrates accessing the conferencing system.

FIG. 3 illustrates a project room.

FIG. 4 illustrates multiple project rooms.

FIG. 5 illustrates e-mail notifications.

### DETAILED DESCRIPTION OF PREFERRED EMBODIMENT

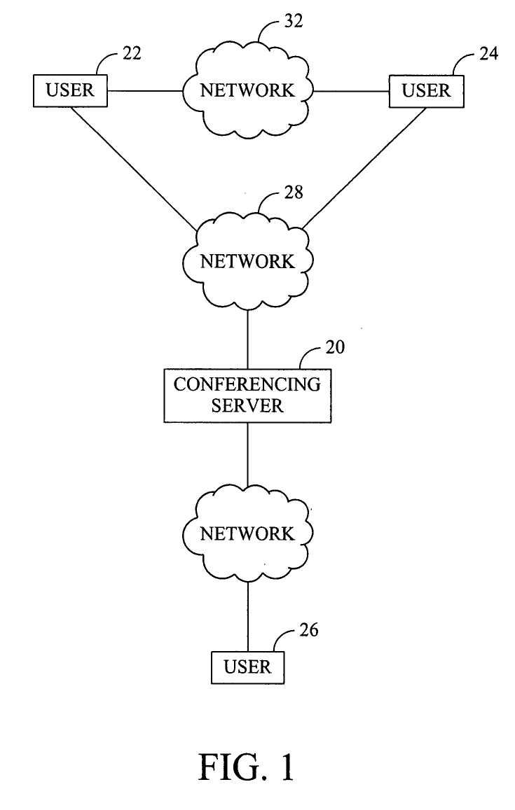

Referring to FIG. 1, a conferencing system 10 typically includes a conferencing server 20. The conferencing server 20 facilitates the interaction between a plurality of users 22, 24, 26. Each of the users typically uses a computer, a video monitor, a microphone, a speaker, a keyboard, a mouse, among other electronic devices. The users 22, 24, 26 are interconnected with the conferencing server through networks 28, 30. The networks 28, 30 may be any type of networks, such as for example, the Internet, wireless network, cellular network, local area network, and wide area network. The users 22 and 24 may likewise be interconnected among themselves, such as a network 32, which may be for example, the Internet, wireless network, cellular network, local area network, and wide area network. Also, the networks 28, 30, 32 may be a combination of different networking technologies. In some cases, the users communicate through the conferencing server 20 to send and receive audio and/or video feeds. Also, in some cases, the users communicate directly among themselves, such as in a peer-to-peer arrangement, to send and receive audio and/or video feeds. In addition, the users may communicate in a client-server manner with the conferencing server 20 (or another user) and/or a peer-to-peer manner among the users. Moreover, the users may share files and/or documents and/or share desktops in a similar manner.

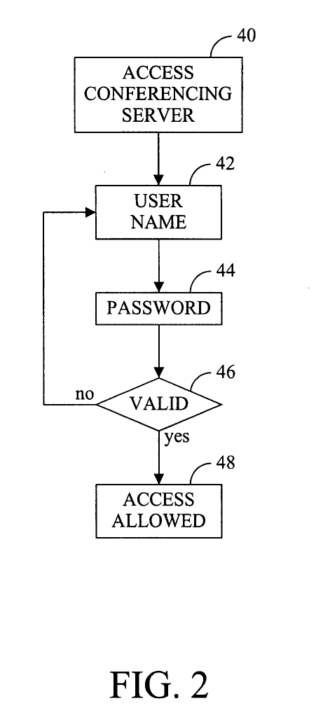

The conferencing system facilitates conferencing sessions for the group of users to get together, typically using the conferencing server 20, to join in a video conference. Referring to FIG. 2, in many cases, each of the users goes through an authentication process in order to log onto the conferencing server. The user typically accesses 40 the conferencing system by initiating conferencing software locally installed on their computer that access the conferencing server 20 or otherwise accesses the conferencing server 20 using a browser through the network. The user then enters his user name 42 for the conferencing server 20. The user then enters his password 44 associated with the user name 42. The conferencing server 20 validates 46 that the user name 42 and password 44 against the user name and password of a valid account on the conferencing server 20. If the account and/or password is not valid then the user is requested to reenter the user name 42 and password 44. If the account and/or password is valid then the access is allowed 48 to the conferencing server 20.

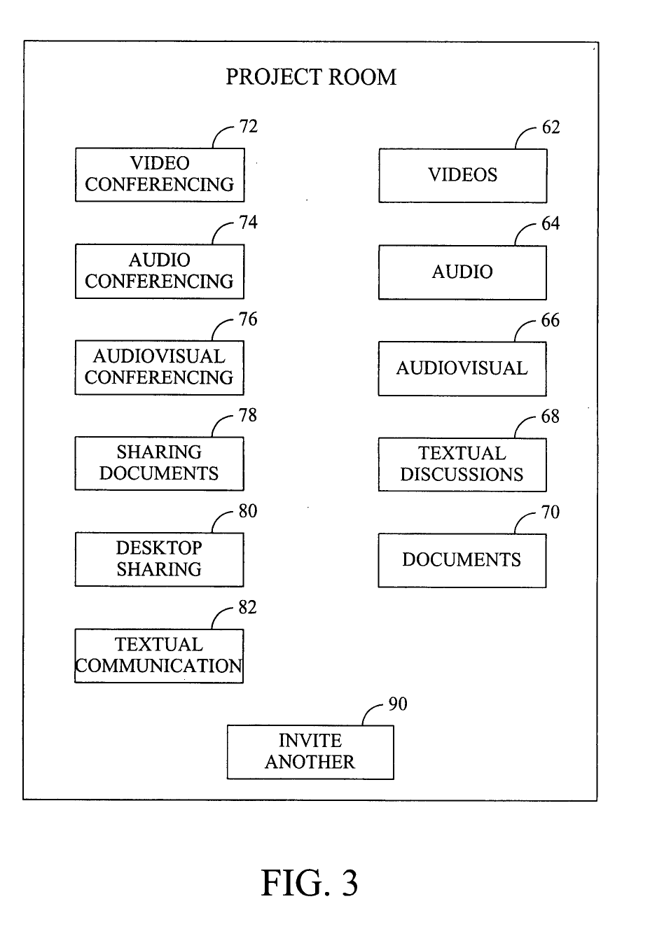

Referring to FIG. 3, the users of the conferencing server 20 may navigate to a project room 60. A project room 60 contains archived videos 62 among users, archived audio 64 among users, archived audiovisual 66 content among users, archived textual discussions 68 among users, documents 70 available among users, and facilitates the interconnection among users of the project room 60 to communicate using video conferencing 72, audio conferencing 74, audiovisual conferencing 76, sharing documents 78, desktop sharing 80, and textual communication 82 (e-mails, text files, instant messaging discussions, etc.). Each of the features 72, 74, 76, 67, 80, and 82 may be initiated by a user and include a group of users within the project room 60. The project room 60 may be available to a select group of users that have particular permissions to access the particular project room 60.

The navigation to the project room 60 may require particular permissions within the system. The conferencing system typically includes a set of menus that need to be navigated in order to locate a particular conference or project. Those with accounts on the system will be able to join a conference after suitable training on the operation of the conferencing system 20. However, those without accounts on the system or otherwise generally unfamiliar with the conferencing system may find it difficult to locate a particular project, navigate the menu system to a particular project, set up permissions to access a particular project, or otherwise locate a file or otherwise once they have gained access to a particular project.

Thus each project room may contain multiple documents, files, and other information which is useful to the members of the project room 60 together with a mechanism for the users to communicate among themselves using a variety of different techniques. The project room 60 may be facilitated through a variety of different interfaces, a single interface, or otherwise. In this manner, the different members of the project room 60 may share information related to the project.

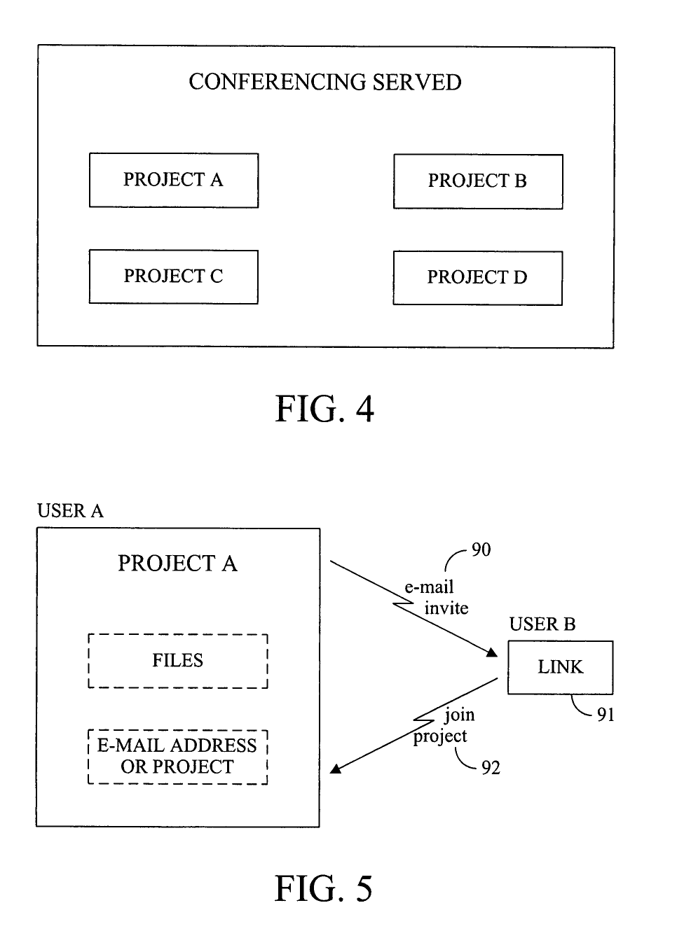

Referring to FIG. 4, the conferencing server 20 may include a plurality of different projects, such as project A, project B, project C, and project D. Users of the system may have access to one or more of the projects. In this manner, different users will have permission to view documents and things in different projects. Also, this permits users to organize their documents and things among the different projects.

Referring to FIG. 5, a modified technique for permitting users who are not members of the project or otherwise members of the conferencing system to view, add, or contribute to the project involves the system including the capability of a user to permit a user to join the project on a temporary basis without requiring all of the typical process to authenticate the user. To facilitate joining, a user may send an e-mail invitation 90 from a particular project to another desired user. The e-mail invitation preferably includes a link 91 with suitable authentication criteria to permit the recipient to directly link into the project area. Upon clicking the link 91 in the e-mail, the user is joined 92 into the project and may access the files contained therein. Other techniques to provide access to a particular project may likewise be used, such as for example, a link through a website, a website that includes project access. In such cases, the user can avoid the general username and/or password authentication process.

A user that is linked into a particular project preferably has its access limited to the project to which they are invited. In some cases, the user will have access to a limited number of projects based upon some permission criteria. In some cases, the user may be linked into a particular file within a project. In other cases, the user may be permitted limited access within a particular project.

The project on the conferencing system also preferably includes a unique e-mail address indicative of the particular project. For example, PROJECT-1023@CONFERENCINGSYSTEM.COM. In this manner, e-mail notification may be manually sent or automatically sent to all or a portion of the users of a particular project to indicate changes in any files in the project. In this manner, users who are not currently accessing a particular project will be notified when changes are made to any or selected ones of the files within the project. In some cases, the e-mail notification may provide direct downloading of modified files without having to log into the conferencing system. This is a convenient management mechanism for members of the project in order to facilitate more interaction among the users.

In some cases, the conferencing system is licensed to a particular entity or group of people. In such cases, the licensing may permit only a limited number of users of the system. In order to expand the set of licensed users, the system may include a floating license that permits a particular user direct access to one or a limited number of projects, with all or a limited set of permitted functions.

The users who are not otherwise members of the conferencing system may determine after using the system that it is a desirable system for some of their uses. This is particularly true of users that linked into a project using an e-mail notification. In order to facilitate the addition of potential users, the system may request some basic contact information from the user. The user may then be contacted to determine if they would be interested in signing up for the service.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A conferencing system comprising:
(a) a plurality of users each of which is interconnected with a conferencing server that permits videoconferencing among said plurality of users;
(b) said conferencing server permitting each of said plurality of users to access a document of said conferencing server using an authentication process;
(c) said conferencing server permitting another user to access said document of said conferencing server without using said authentication process;
(d) wherein said another user accessing said document is in response to a request by one of said plurality of users.

2. The conferencing system of claim 1 wherein said plurality of users each have a computer.

3. The conferencing system of claim 1 wherein said users are interconnected with said conferencing server though a network.

4. The conferencing system of claim 1 wherein said document is a video.

5. The conferencing system of claim 1 wherein said document is textual communication using a messaging system.

6. The conferencing system of claim 1 wherein said authentication process includes a user name and a password.

7. The conferencing system of claim 1 wherein said without said authentication process does not include a user name and a password.

8. The conferencing system of claim 1 wherein said authentication permits access to a project room that includes stored files for said plurality of users.

9. The conferencing system of claim 8 wherein said without said authentication process permits access to said project room.

10. The conferencing system of claim 1 wherein said authentication process permits access to one of a plurality of project rooms.

11. The conferencing system of claim 10 wherein said without said authentication process permits access to one of said project rooms.

12. The conferencing system of claim 10 wherein said project room has a unique e-mail address.

13. The conferencing system of claim 1 wherein said without said authentication process is based upon an e-mail.
